(19) United States
(12) Patent Application Publication
(10) Pub. No.: US 2019/0381745 A1
(43) Pub. Date: Dec. 19, 2019

(54) Process for plastic welding with low deformation

(71) Applicants: Ying Wang, Irvine, CA (US); MINGANG LI, Shanghai (CN); Jing Han, Shanghai (CN)

(72) Inventors: Ying Wang, Irvine, CA (US); MINGANG LI, Shanghai (CN); Jing Han, Shanghai (CN)

(21) Appl. No.: 16/009,199

(22) Filed: Jun. 15, 2018

(51) Int. Cl. B29C 65/00; B29C 65/16

(52) U.S. Cl. CPC B29C 66/0342; B29K 2105/16; B29C 65/1635

(57) ABSTRACT

The present invention relates to plastic welding process comprising using a dynamic heatsink that minimize the temperature rise of the predetermined surface whereby the surface quality of plastic welding is maintained.

### FIELD OF THE INVENTION

The present invention is related to a surface-quality maintaining method in welding of two plastic components by radiation.

### BACKGROUND OF THE INVENTION

Methods for plastic welding of parts are already known in which the welding energy is supplied by a radiation source such as a lamp or a laser. Generally, in a transmission technique welding methods are known in which the radiation or laser beam is directed through a transparent component onto a second component which absorbs the laser beam. Because of the absorption, the illuminated surface of the second component is strongly heated, until melting of the material takes place. When the transparent component is put in close contact with the second component, and the fused portion gets in touch with the material of the transparent component, this material is also melted, so that welding of the two components takes place. In order to guarantee contact of the fused portion of the absorbing material with the transparent material, the two components are pressed together during welding. In many applications, the surface quality of the “transparent” component is not critical due to the nature of the application. In other cases, the temperature of the transparent component would not reach the point of deformation because of its high transmission to the radiation beam or because the heat at the melt could not reach the surface due to the thickness of the transparent material during the welding process. However, in many situation deformation to the “transparent” component will occur due to the thin thickness could not prevent the heat from the melt spreading to the surface of the “transparent” component, or in many other cases, the transparent component is not fully transparent due to the presence of additives, colors, fillers, fibers or other materials. For example, when a “transparent” material with only 15% of transmission to a laser beam is welded to another component with high absorption, it is highly difficult to avoid the surface damage to the “transparent” component. In some cases, a window or a liquid filled cell is used to press the transparent component against the absorbent component, such as disclosed in U.S. Pat. No. 6,486,433, but these setup is not enough to remove heat that could cause surface deformation. In another case, such as disclosed in U.S. Pat. No. 5,949,959, a heatsink is used to filter desired wavelength, but this cannot remove heat from the “transparent” layer in the transmission welding process. Moreover, it is not suitable for laser welding process because most of the time laser is monochromatic with no “undesired” wavelength to filter. Therefore, there exists a need to a process or method that could maintain the surface quality of the “transparent” component while achieving good welding of the plastic components, particularly when the “transparent” component is not very transparent or when it is very thin.

It is therefore the object of the present invention to propose a method of plastic welding which can minimize the surface deformation even when the transparent component has low transmission to the radiation beam or even the thickness of the transparent component is thin. It is another objective of the invention to provide a method of maintaining surface quality during the radiation welding of two plastic materials by cooling the top surface of a first material illuminated by radiation so that the deformation to the surface by heat from absorption of the radiation or from the melt is avoided or minimized. It is another objective of the invention to provide method of maintaining surface quality during plastic welding by using a dynamic heatsink comprising a flowing cooling fluid that is substantially transparent the radiation wherein the undesired heat is removed by the flowing cooling fluid. It is yet another objective of the invention to provide method of maintaining surface quality during plastic welding by using a transparent heatsink that removes heat from the surface illuminated by the radiation continuously so the surface quality of the said surface is kept intact. It is yet another objective of the invention to provide method of welding a partially transparent plastic with a plastic material absorbent to radiation without deformation to the surface of the partially transparent plastic material. The radiation source can be selected from laser diode, light emitter diode (LED) or other light sources such as a lamp. Other objects of the invention will become apparent to those with ordinary skill in the art from consideration of the present disclosure.

### SUMMARY OF THE INVENTION

The object is achieved according to the invention by means of a method having the features of the independent method claim and of the device claim. Further advantageous refinements are specified in the respective subclaims that refer back.

In accordance with the method according to the invention, the guiding of the radiation beam onto the site to be joined, and the cooling to the first surface of two components pressed together for welding are carried out simultaneously by using a dynamic heatsink on the first surface of the components that the radiation first reaches. The dynamic heatsink, such as a flowing cooling medium, is substantially transparent to the radiation for welding and the dynamic heatsink removes heat continuously from the components and essentially prevents this first surface from being heated up to the point of causing deformation, while the radiation melts mutually bordering contact surface for the two components. In accordance essence of this invention, a method is disclosed for welding two plastic components, comprising providing a radiation source for emitting a radiation beam; providing a first component, comprising a plastic material, having a first surface and a second surface; providing a second component, comprising a material absorbent to the said radiation beam, being pressed against the second surface of said first component; providing a dynamic heatsink substantially transparent to said radiation beam, said dynamic heatsink being placed on the first surface of said first component and continuously removing heat from said first surface of said first component, wherein mutually bordering contact surface for the two components is melted under the effect of said radiation beam and joined to one another under pressure and subsequent cooling, wherein the surface quality of the first surface of said first component is maintained by the cooling provided by said dynamic heatsink.

In accordance with another preferred embodiment of the method, a method for welding two plastic components is implemented, comprising, providing a radiation source for emitting a radiation beam; providing a first component, comprising a plastic material having a first surface and a second surface; providing a second component, comprising a material absorbent to the said radiation beam, being pressed against the second surface of said first component; providing a heat conducting thin material, substantially transparent to said radiation beam, having first and second side, with said second side of said heat conducting thin material being in close contact with the first surface of said first component; providing a dynamic heatsink substantially transparent to said radiation beam, said dynamic heatsink being placed on the first side of said heat conducting thin material and continuously removing heat from said first surface of said first component through said heat conducting thin material, wherein mutually bordering contact surface for the two components is melted under the effect of said radiation beam and joined to one another under pressure and subsequent cooling, wherein the surface quality of the first surface of said first component is maintained by the cooling provided by said dynamic heatsink. In accordance with another preferred embodiment of the method, a method for welding two plastic components is disclosed, comprising, providing a radiation source for emitting a radiation beam; providing a first component, comprising a plastic material having a first surface and a second surface; providing a second component, comprising a material absorbent to the said radiation beam, being pressed against the second surface of said first component; providing a heat conducting material, substantially transparent to said radiation beam, having first and second side, with said second side of said heat conducting material being in close contact with the first surface of said first component; providing a dynamic heatsink substantially transparent to said radiation beam, said dynamic heatsink being placed on said first side of said heat conducting material and continuously removing heat from said first surface of said first component through said heat conducting material, wherein mutually bordering contact surface for the two components is melted under the effect of said radiation beam and joined to one another under pressure and subsequent cooling, wherein the surface quality of the first surface of said first component is maintained by the cooling provided by said dynamic heatsink.

The invention thereby renders it possible in principle to complete welding of two plastic components without deformation to the outer surface exposed to the radiation source. Other objects of the invention will become apparent to those with ordinary skill in the art from consideration of the present disclosure.

### BRIEF DESCRIPTION OF THE DRAWINGS

FIG. 1 shows a prior art of transmission plastic welding.

FIG. 2 shows an exemplary embodiment.

FIG. 3 shows a second exemplary embodiment.

FIG. 4 shows another exemplary embodiment, wherein the dynamic heatsink conforms to the surface profile of the first surface of the first component.

FIG. 5 shows another exemplary embodiment, wherein the dynamic heatsink is separated from the first surface of the first component by a heat conducting thin material.

FIG. 6 shows yet another exemplary embodiment, wherein the dynamic heatsink is separated from the first surface of the first component by a heat conducting thin material, and the matched or conformed surface profiles minimizes the heat resistance between the dynamic heatsink 8 and the first surface of the first component.

FIG. 7 shows another exemplary embodiment, wherein the first surface of the first component is submerged in the dynamic heatsink comprising a flowing cooling medium.

### DETAILED DESCRIPTION OF THE INVENTION

The present invention relates to a radiation welding method for a first plastic component, having a first surface and a second surface, being partially or substantially transparent to the radiation, and a second plastic component, being radiation-absorbent and pressed against the second surface of the first plastic component, wherein a dynamic heatsink is provided to the first surface of said first plastic component to prevent surface deformation when a radiation beam from a radiation source passes through said first component and leads to the welding between said first and second plastic components. One preferred radiation source is a laser source.

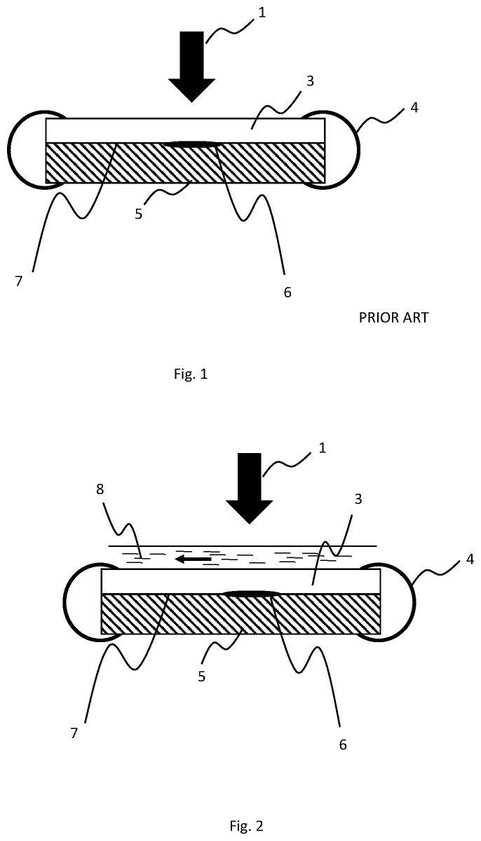

Transmission radiation welding is a technique which was developed for welding together materials such as plastics. This is achieved by bringing two plastic components into contact with one another, wherein one thereof is transparent to the radiation, such as a laser beam, and the other is opaque or absorbent to the radiation. As illustrated in FIG. 1, the first transparent plastic component 3 has a first surface and a second surface. The second component 5 comprises a material absorbent to the radiation, being pressed by a clamping mechanism 4 against the second surface of the first component 3; The area of contact 7 between the two plastic components is then exposed to the radiation beam 1, such as a laser beam, in a predetermined manner. The radiation or laser beam enters form the first surface of the first component, passes through the transparent plastic component and is absorbed by the second component 5. This causes the absorbent plastic component in 5 to warm, so that the area of contact between the two plastic components melts, resulting in the formation of a weld site 6. However, in many applications, the so-called transparent plastic component is not so transparent since it is modified with color, pigment or fillers or it is somewhat absorbent to the radiation due to the molecular structure of the material. In this case, deformation to the “transparent” component could occur because of the heat generated by partial absorption of the “transparent” plastic component. This is particularly the case when the thickness of the transparent component is thin when the heat from the melt could quickly spread into the “transparent” component besides the heat caused by its own absorption to the radiation. In this case, it is often highly difficult to avoid the surface damage to the “transparent” component. Although in some disclosure, a window or a pressure cell is used as clamping mechanism in the welding process, it is not sufficient to prevent surface deformation during the radiation transmission welding process either because the purpose was not for cooling so no special attention was made in material selection or the stationary setup could not remove heat continuously. The main object of the present invention is therefore to find method which enable good welding of two plastic components by radiation while causing no deformation to the surface where the radiation, such as a laser beam, enters the plastic component. The methods disclosed in this invention solve the problem by providing a dynamic heatsink to the transparent component. Thus it is preferred that a cooling liquid such as water is used as a dynamic heatsink on the surface of the “transparent” component.

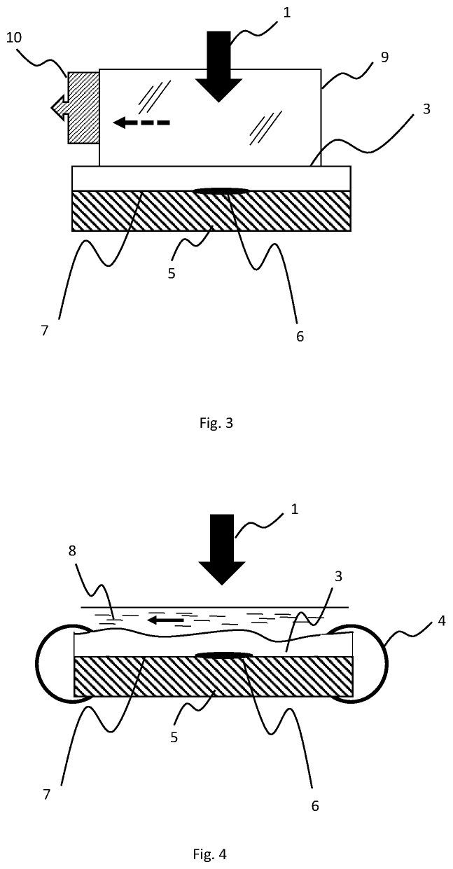

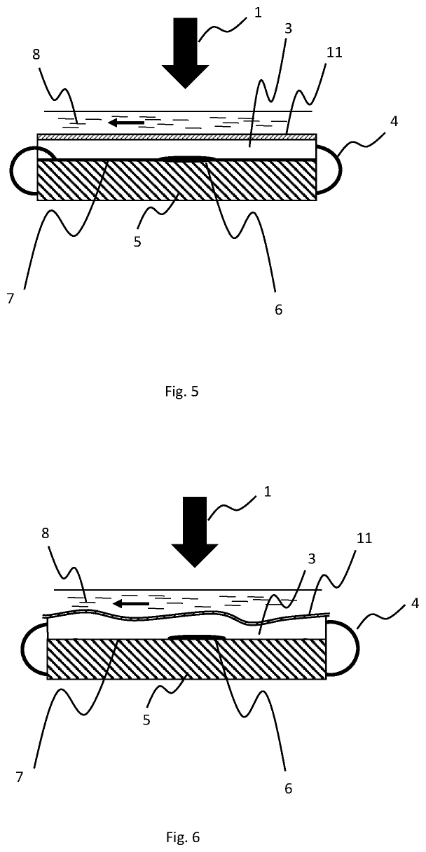

FIG. 2 shows one preferred embodiment of this invention. In this method for welding two plastic components, comprising, providing a radiation source (not shown) for emitting a radiation beam 1; providing a first component 3, comprising a plastic material having a first surface and a second surface; providing a second component 5, comprising a material absorbent to the said radiation beam, being pressed against the second surface of said first component; providing a dynamic heatsink 8 substantially transparent to said radiation beam, said dynamic heatsink being placed on the first surface of said first component and continuously removing heat from said first surface of said first component, wherein mutually bordering contact surface 7 for the two components is melted under the effect of said radiation beam and joined to one another under pressure and subsequent cooling, wherein the surface quality of the first surface of said first component is maintained by the cooling provided by said dynamic heatsink. In this method it is preferred to use a flowing cold gas or liquid, such as water, as said dynamic heatsink, covering the first surface of said first component illuminated by said radiation beam and removing the heat from the first component continuously. One of the advantages of this method is that the dynamic heatsink will conform to the shape of the first surface of said first components as shown in FIG. 4. The dynamic heatsink can also be a solid as illustrated in FIG. 3. In this case, radiation-transparent material of high thermal conductivity must be used, and a cold source 10 is made in contact with the solid dynamic heatsink 9 so the heat from the first surface of said first component generated from the illumination of said radiation beam is removed continuously. It is preferred that the thermal conductivity of the solid dynamic heatsink is more than 10 W/mK. For example, the solid dynamic heatsink 9 can comprise a sapphire block that is further cooled by an external cooling source 10. The dash arrow in FIG. 3 illustrates the continuous heat removal from the first component. Materials with lower thermal conductivity as said solid dynamic heatsink have shown to be less effective in maintaining good surface quality during the welding process. In the process using a flowing fluid, due to the effectiveness of the dynamic heatsink, the surface quality of the first component can be effectively maintained even if the “transparent” first component has an unusually high absorption or the first component comprises fillers. The temperature of the flowing fluid could be made low enough to prevent deformation to the cooled surface of the first component. It is preferred that said first component has at least 5% transmission to said radiation beam. While either the first or the second component often has fillers, the method disclosed in this invention can effectively prevent surface deformation to the first component during transmission plastic welding.

FIG. 5 shows another preferred embodiment of this invention. In this method for welding two plastic components, comprising, providing a radiation source (not shown) for emitting a radiation beam 1; providing a first component 3, comprising a plastic material having a first surface and a second surface; providing a second component 5, comprising a material absorbent to the said radiation beam, being pressed against the second surface of said first component by a clamping mechanism 4; providing a heat conducting thin material, such as a film 11, substantially transparent to said radiation beam, having first and second side, with said second side of said heat conducting material or film being in close contact with the first surface of said first component; providing a dynamic heatsink 8 substantially transparent to said radiation beam, said dynamic heatsink being placed on the first surface of said heat conducting material or film, and continuously removing heat from said first surface of said first component through said heat conducting material or film, wherein said radiation beam illuminates said components in a predetermined manner, and mutually bordering contact surface 7 for the two components is melted under the effect of said radiation beam, forming a melting site 6 where the radiation hits, and joined to one another under pressure and subsequent cooling, wherein the surface quality of the first surface of said first component is maintained by the cooling provided by said dynamic heatsink. The dynamic heatsink can be a flowing water or other liquid and the temperature of the dynamic heatsink can be adjusted as low as required.

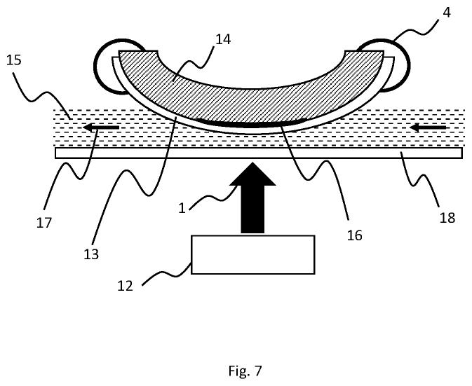

FIG. 6 illustrates another preferred embodiment of this invention that is similar to the embodiment in FIG. 5, but the first component has a non-planar shape. In this embodiment, said heat conducting film or material 11 in contact with the first surface of said first component has a predetermined surface profile matching the surface profile of the first surface of said first component, wherein the matched contact between said heat conducting film and the first surface of said first component minimizes the heat resistance between said dynamic heatsink and the first surface of said first component so the dynamic heatsink 3 in contact with 11 can remove heat from said first component through 11 effectively to prevent deformation to the first surface of the first component. In this preferred embodiment, the heat conducting film or material 11 can also be a soft material capable of conforming to the first surface of said first component, minimizes the heat resistance between said dynamic heatsink and the first surface of said first component so heat can be removed effectively from the first component by said dynamic heatsink.

FIG. 7 shows another preferred embodiment of this invention showing a method for minimizing surface deformation in plastic welding by radiation, comprising the steps of: emitting a radiation beam 1 from a radiation source 12; providing a first component 13, comprising a plastic material, having a first surface and a second surface; providing a second component 14, absorbent to said radiation with one surface of said second component being pressed against the second surface of said first component by a clamping mechanism 4; providing a heat exchanger 15, being placed in between said radiation source and the first surface of said first component, comprising a flowing cooling medium, with the first surface of said first component being submerged in said flowing cooling medium; wherein said radiation passes through said flowing cooling medium of the heat exchanger, through said first component and form a melt site 16 on the mutually bordering contact surface for the two components, wherein the surface quality of the first surface of said first component is maintained by the cooling provided by said flowing cooling medium. The small arrows 17 in FIG. 7 illustrate the flow of said flowing cooling medium. Said heat exchanger can further include a window 18 located between said radiation source and said flowing cooling medium. In this and other embodiment, a welding track or welding line can be formed by either scanning of said radiation beam on said components in a predetermined manner, or by using a radiation beam with a beam spot of a shape of the desired welding track. Although to people in the art it is obvious that many types of radiation can be used in implement of the current invention, laser beam is often more convenient to use. The laser could be selected from any wavelength range as long as it is suitable for the transmission welding process based on the properties of plastic components, and as long as it has a minimized absorption by the dynamic heatsink. Corresponding lasers which are suitable for the laser welding of the polymers according to the invention are often commercially available.

The invention claimed is:

1. A method for welding two plastic components, comprising
providing a radiation source for emitting a radiation beam;
providing a first component comprising a plastic material having a first surface and a second surface;
providing a second component, comprising a material absorbent to the said radiation beam, being pressed against the second surface of said first component;
providing a dynamic heatsink substantially transparent to said radiation beam, said dynamic heatsink being placed on the first surface of said first component and continuously removing heat from said first surface of said first component, wherein mutually bordering contact surface for the two components is melted under the effect of said radiation beam and joined to one another under pressure and subsequent cooling, wherein the surface quality of the first surface of said first component is maintained by the cooling provided by said dynamic heatsink.

2. A method as claimed in claim 1, wherein said first component has at least 5% transmission to said radiation beam.

3. A method as claimed in claim 1, wherein said dynamic heatsink is a flowing cold gas covering the first surface of said first component illuminated by said radiation beam.

4. A method as claimed in claim 1, wherein said dynamic heatsink is heat conducting solid, connecting to a cold source and removing heat from said first surface of said first component continuously, wherein the thermal conductivity of said heat conducting solid is at least 10 W/mK.

5. A method as claimed in claim 1, wherein said dynamic heatsink comprising a flowing liquid, wherein the temperature of said flowing liquid being low enough to avoid deformation to said first surface of said first component by said radiation beam.

6. A method for welding two plastic components, comprising
providing a radiation source for emitting a radiation beam;
providing a first component, comprising a plastic material having a first surface and a second surface;
providing a second component, comprising a material absorbent to the said radiation beam, being pressed against said second surface of said first component;
providing a heat conducting thin material, substantially transparent to said radiation beam, having first and second side, with said second side of said heat conducting thin material being in close contact with said first surface of said first component;
providing a dynamic heatsink substantially transparent to said radiation beam, said dynamic heatsink being placed on said first side of said heat conducting thin material and continuously removing heat from said first surface of said first component through said heat conducting thin material, wherein mutually bordering contact surface for the two components is melted under the effect of said radiation beam and joined to one another under pressure and subsequent cooling, wherein the surface quality of said first surface of said first component is maintained by the cooling provided by said dynamic heatsink.

7. A method as claimed in claim 6, wherein said dynamic heatsink comprising a flowing liquid, wherein the temperature of said flowing liquid being low enough to avoid deformation to said first surface of said first component by said radiation beam.

8. A method as claimed in claim 6, wherein said heat conducting thin material has a predetermined surface profile matching the surface profile of the first surface of said first component, whereby the close contact from the matched surface profile minimizing heat resistance between said dynamic heatsink and the first surface of said first component.

9. A method as claimed in claim 6, wherein said heat conducting thin material is a soft material capable of conforming to said first surface of said first component, and minimizing the heat resistance between said dynamic heatsink and said first surface of said first component.

10. A method as claimed in claim 1, wherein at least one said component further including fillers.

11. A method for minimizing deformation in plastic welding by radiation, comprising the steps of:
emitting said radiation from a radiation source;
providing a first component, comprising a plastic material, having a first surface and a second surface;
providing a second component absorbent to said radiation with one surface of said second component being pressed against the second surface of said first component;
providing a heat exchanger, being placed in between said radiation source and the first surface of said first component, comprising a flowing cooling medium, with said first surface of said first component being submerged in said flowing cooling medium;
wherein said radiation passes through said flowing cooling medium of the heat exchanger, through said first component and melts the mutually bordering contact surface for the two components, wherein the surface quality of the first surface of said first component is maintained by the cooling provided by said flowing cooling medium.

12. A method as claimed in claim 11, said heat exchanger further including a window located between said radiation source and said flowing cooling medium.
